(19) United States
(12) Patent Application Publication
(10) Pub. No.: US 2017/0217318 A1
(43) Pub. Date: Aug. 3, 2017

(54) BATTERY PACK CONFIGURATION

(71) Applicant: Faraday&Future Inc., Gardena, CA (US)

(72) Inventor: Daniel Kowalewski, Redondo Beach, CA (US)

(21) Appl. No.: 15/010,757

(22) Filed: Jan. 29, 2016

(51) Int. Cl. B60L 11/18; H02M 3/00; H02M 7/44; H02J 1/00

(52) U.S. Cl. CPC B60L 11/18; H02J 1/00; H02M 3/00; H02M 7/44

(57) ABSTRACT

A reconfigurable battery pack is disclosed. The reconfigurable battery back includes plurality of reconfigurable units, such as cells, and switches or selectors coupled to the reconfigurable units within the reconfigurable battery pack. The switches or selectors can be controlled to reconfigure the electric connectivity among the reconfigurable units and to the loads having different power or voltage specifications that are directly connected to and powered by the reconfigurable battery pack.

### BACKGROUND

Field

The described technology generally relates to automobiles, more specifically, to battery systems in electric vehicles.

Description of the Related Art

Managing a power source in a system requiring different levels of voltage, such as an electric vehicle, can be challenging especially when the requisite levels of voltage differs greatly in magnitude. To provide different levels of direct current (DC) voltage to a system, a DC/DC converter and/or multiple voltage sources can be used to power different subsystems at different voltage or power levels.

### SUMMARY

The methods and devices of the described technology each have several aspects, no single one of which is solely responsible for its desirable attributes.

In one implementation, an apparatus includes a battery pack including a plurality of battery units and a plurality of reconfiguration switches coupled to the plurality of battery units, and a controller coupled to the battery pack, the controller being configured to activate one or more reconfiguration switches, wherein at least one of the plurality of battery units is connectable in a first state or a second state when the one or more reconfiguration switches are activated, the first state being coupled to a first load providing a first voltage, and the second state being coupled to a second load providing a second voltage.

In another implementation, a reconfigurable battery pack includes a dedicated voltage source portion configured to provide power to a high voltage load and a reconfigurable voltage source portion configured to provide power to either a high voltage load or a low voltage load.

In another implementation, an electric vehicle includes a motor coupled to one or more wheels of the electric vehicle, an inverter coupled to the motor, at least a first power bus coupled to the inverter, a low voltage load isolated from the first power bus, and a reconfigurable battery pack directly coupled to the first power bus and the low voltage load.

### BRIEF DESCRIPTION OF THE DRAWINGS

These drawings and the associated description herein are provided to illustrate specific embodiments of the invention and are not intended to be limiting.

FIG. 1 is a block diagram of a direct current (DC) powering system.

FIG. 2A is a block diagram of a DC powering system with an example reconfigurable battery according to one embodiment.

FIG. 2B is a block diagram of another DC powering system with an example reconfigurable battery according to one embodiment.

FIG. 3A is a first block diagram of an example reconfigurable battery pack according to one embodiment.

FIG. 3B is a second block diagram of an example reconfigurable battery pack according to one embodiment.

FIG. 4 is a circuit diagram of an example reconfigurable battery pack according to one embodiment.

FIG. 5 is an example application of a reconfigurable battery pack in an electric vehicle.

### DETAILED DESCRIPTION

Various aspects of the novel systems, apparatuses, and methods are described more fully hereinafter with reference to the accompanying drawings. Aspects of this disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the novel systems, apparatuses, and methods disclosed herein, whether implemented independently of or combined with any other aspect. For example, an apparatus may be implemented or a method may be practiced using any number of the aspects set forth herein. In addition, the scope is intended to encompass such an apparatus or method which is practiced using other structure, functionality, or structure and functionality in addition to or other than the various aspects set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to automotive systems and/or different wired and wireless technologies, system configurations, networks, including optical networks, hard disks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

A reconfigurable battery pack is disclosed. The reconfigurable battery back includes plurality of reconfigurable units, such as cells, and switches or selectors coupled to the reconfigurable units within the reconfigurable battery pack. The switches or selectors can be controlled to reconfigure the electric connectivity among the reconfigurable units and to the loads having different power or voltage specifications that are directly connected to and powered by the reconfigurable battery pack.

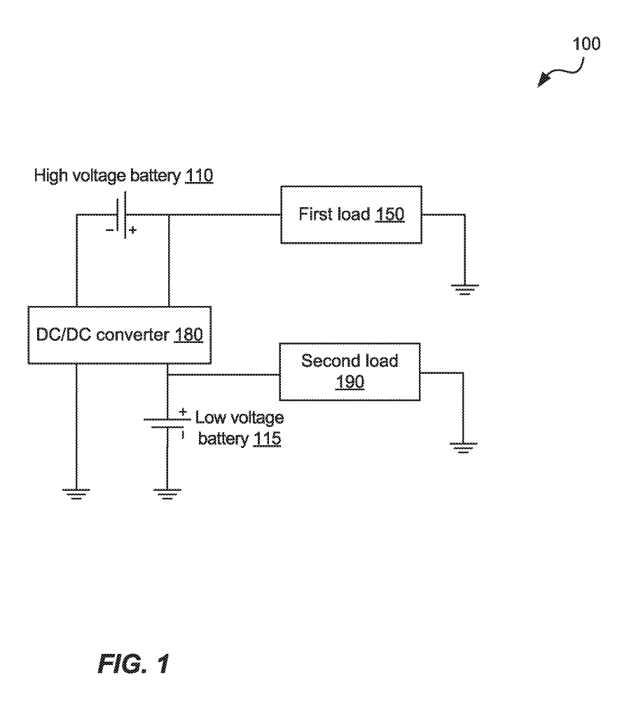

FIG. 1 is a block diagram of a direct current (DC) powering system. The illustrated DC powering system 100 includes a high voltage (HV) battery 110 providing power to a first load 150, a low voltage (LV) battery 115 providing power to a second load 190, and a DC/DC converter 180 converting a high DC voltage of the high voltage battery 110 to a lower DC voltage to allow the high voltage battery 110 to charge the low voltage battery 115 as typical. The illustrated powering system 100 can, for example, be implemented in an electric vehicle with the first load 150 being a load typically requiring high voltage, such as a vehicle drive system, and the second load 190 being a load typically requiring low voltage, such as a vehicle entertainment system.

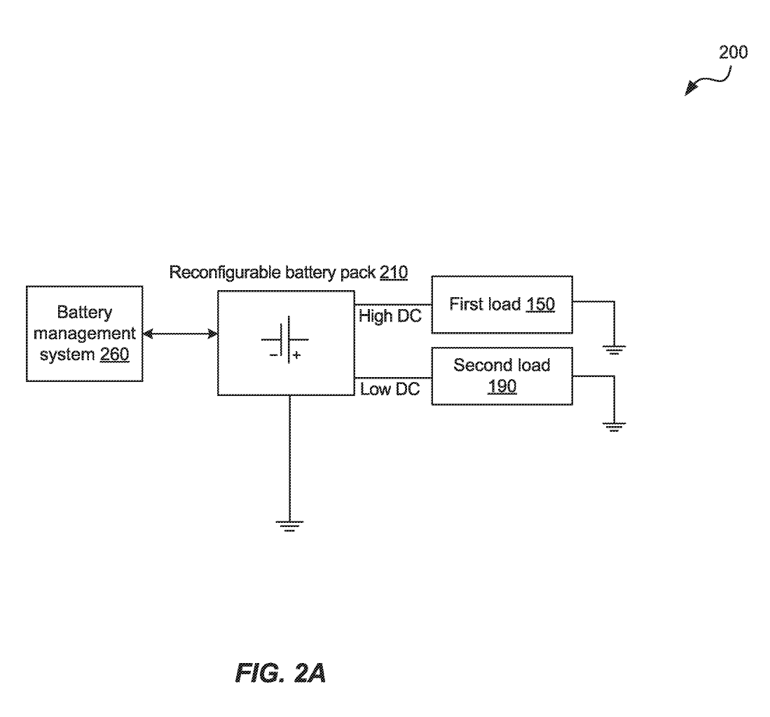

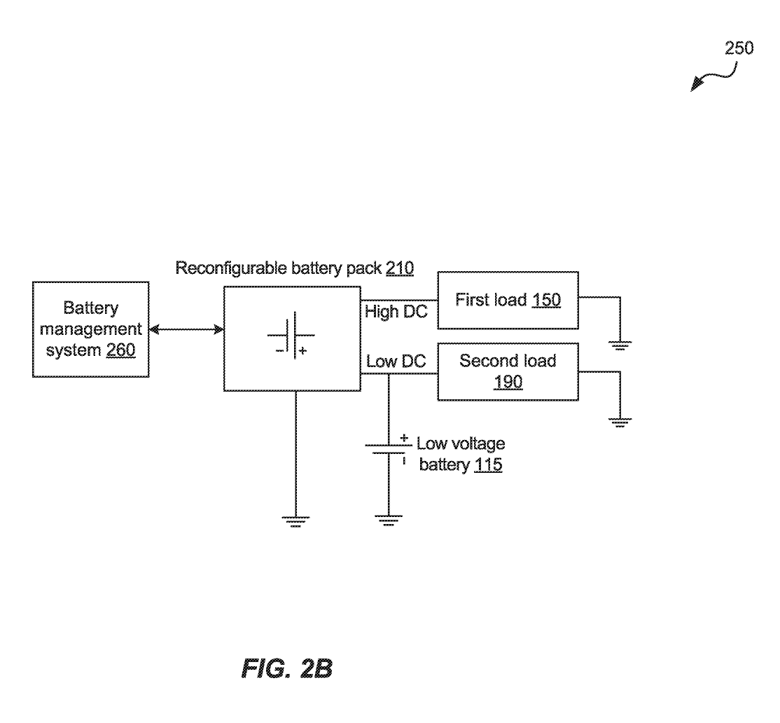

FIG. 2A is a block diagram of a DC powering system with an example reconfigurable battery according to one embodiment. The illustrated DC powering system 200 includes a reconfigurable battery pack 210 providing high DC voltage to the first load 150 and low DC voltage to the second load 190, and a battery management system 260 in communication with the reconfigurable battery pack 210. The terms “high” voltage and “low” voltage used herein generally denotes the relative levels of voltages provided to the loads powered by the batteries disclosed herein, and the terms “high” and “low” are not limited to any absolute levels of voltages. As generally described herein, a load operating with a “high” voltage and a load operating a “low” voltage can indicate that the voltage differential between the “high” and “low” voltages can be significant enough that a direct coupling or shorting of the “high” voltage and the “low” voltage of the loads would cause the loads to malfunction due to significant current surge. When the disclosed herein is implemented in an electric vehicle, the “high” voltage load can be provided with voltages in the order of hundreds of volts, e.g., about 400 V, while the “low” voltage load can be provided with voltages in the order of a few tens of volts at most, e.g., less than 20 V.

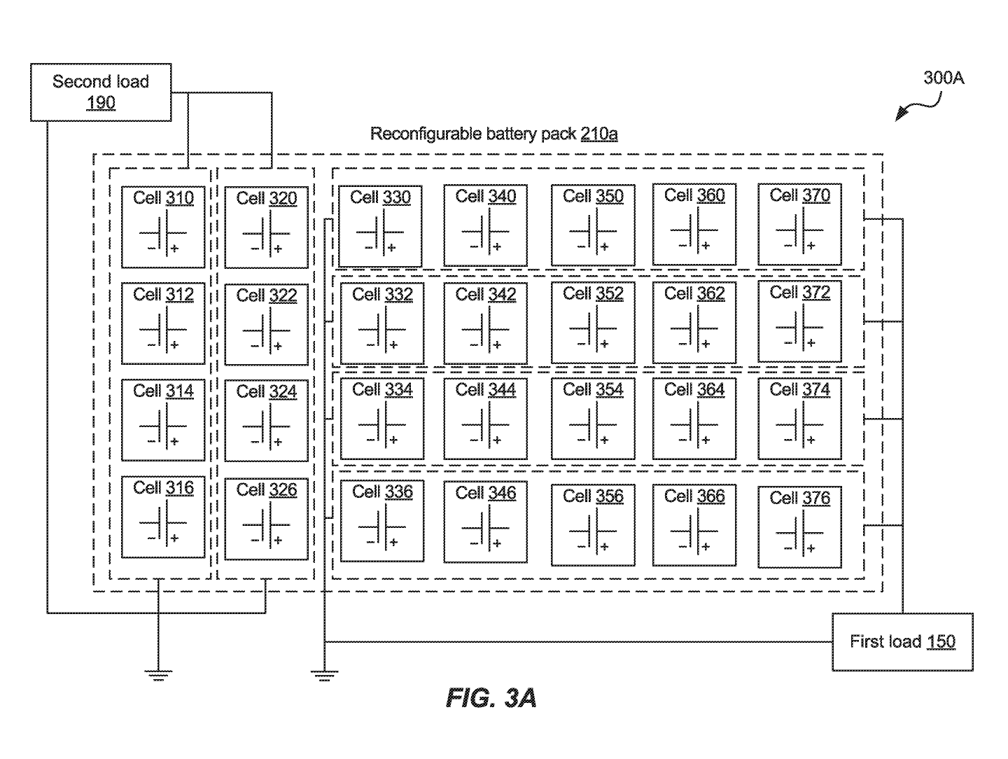

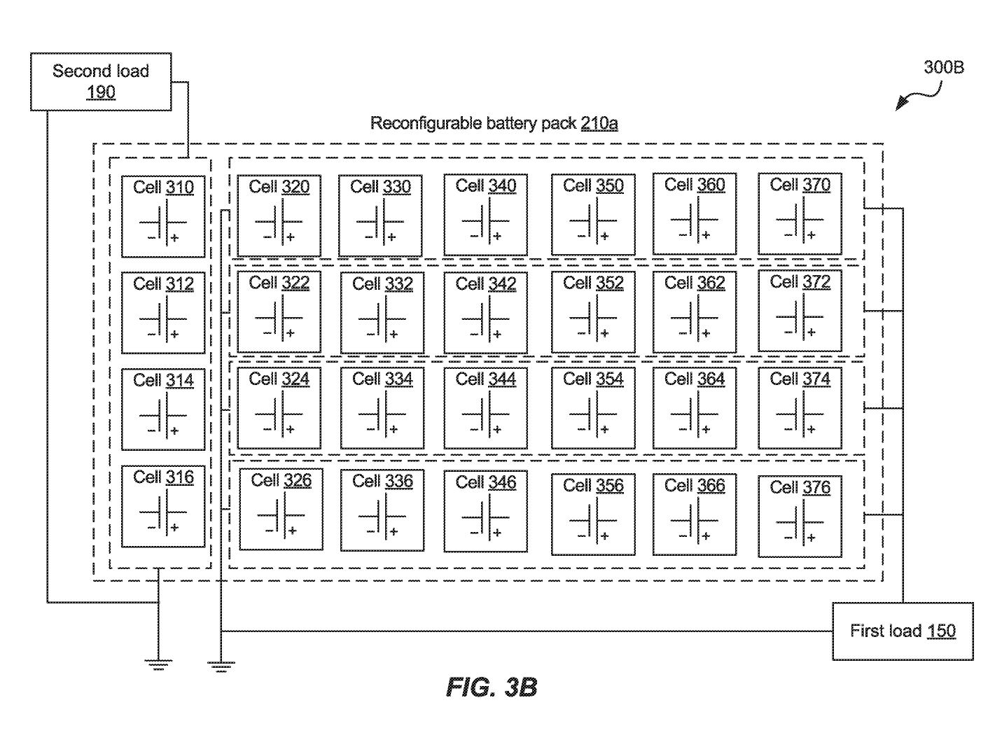

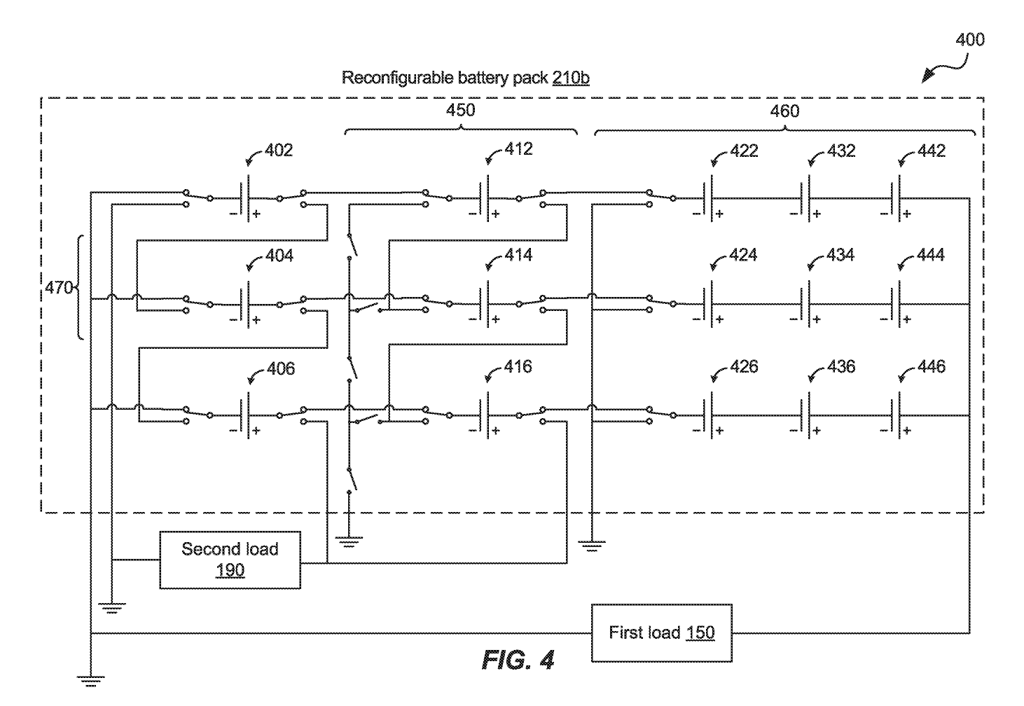

Although the reconfigurable battery 210 is illustrated as a single element in FIG. 2, the reconfigurable battery 210 depicted in FIG. 2 is only representational, and further details of the reconfigurable battery 210 are discussed below in connection with FIGS. 3-4. The reconfigurable battery 210 can be a single phase direct current (DC) source. In some embodiments, the battery 210 can be a rechargeable electric vehicle battery or traction battery. As illustrated in FIG. 2A, the reconfigurable battery pack 210 can be directly coupled to the first load 150 and the second load 190 providing high power to the first load 150 and low power to the second load 190 without, for example, a DC/DC converter to convert the high DC voltage to a low DC voltage. In some embodiments, the reconfigurable battery pack 210 may include a plurality of battery strings, which can be individually or collectively connected to or disconnected from a positive or high power bus and a negative or low power bus through a plurality of switches or contactors. Each of the battery strings may include a plurality of battery modules, and each of the battery modules may include a plurality of battery cells. In such embodiments, within each battery string, the constituent modules and cells can be connected in series. In some embodiments, the reconfigurable battery pack 210 can include six battery strings that can be connected to or disconnected from the power buses, and the battery strings can be implemented with various different types of rechargeable batteries made of various materials, such as lead acid, nickel cadmium, lithium ion, or other suitable materials. In some embodiments, each of the battery strings can output about 375 V to 400 V if charged about 80% or more. Further details of the reconfigurable battery pack 210 are discussed in connection with FIGS. 3A-4.

The battery management system 260 can be in communication with the reconfigurable battery pack 210 to monitor and control the battery performance and status, obtain various data, such as voltage, current, and temperature, execute battery management algorithms, and control reconfiguration of the reconfigurable battery pack 210. In some embodiments, the battery string switches can be controlled by control signals from the battery management system 260. The battery management system 260 can include a plurality of passive and/or active circuit elements, signal processing components, such as analog-to-digital converters (ADCs), amplifiers, buffers, drivers, regulators, or other suitable components. In some embodiments, the battery management system 260 can also include one or more processors to process incoming data to generate outputs, such as the battery string switch control signals or reconfiguration control signals to the reconfigurable battery pack 210.

FIG. 2B is a block diagram of another DC powering system with an example reconfigurable battery according to one embodiment. The DC powering system 250 illustrated in FIG. 2B includes components corresponding to the components of the system illustrated in FIG. 2A, except that the system 250 illustrated in FIG. 2B includes a low voltage battery 115 directly coupled to the reconfigurable battery pack 210. In this example, the low voltage battery 115 can be a rechargeable battery that is charged by the reconfigurable battery pack 210 through its direct coupling without, for example, a DC/DC converter.

FIGS. 3A-3B are block diagrams of an example reconfigurable battery pack according to one embodiment. The illustrated reconfigurable battery pack 210a includes a plurality of cells whose connectivity can be reconfigured within the reconfigurable battery pack 210. Although the cells in the reconfigurable battery pack 210a are illustrated as a single reconfigurable element in FIGS. 3A-3B, the cells depicted in FIGS. 3A-3B are only representational. It is to be noted that the unit of reconfigurability need not be at the cell level of the battery pack 210. Also, it is to be noted that the reconfigurable battery pack 210a in FIGS. 3A-3B is only one example embodiment of the reconfigurable battery pack 210, and the reconfigurable battery pack 210 can include more or less cells or reconfiguration units in other embodiments. Also, it is to be noted that although the cells in reconfigurable battery pack 210 may be referred to as columns of cells or rows of cells, the designation of columns or rows does not indicate particular physical orientation with reference to any absolute coordinate.

In this example diagram 300A in FIG. 3A, the reconfigurable battery pack 210a has 4 rows and 7 columns of cells. The example reconfigurable battery pack 210a in FIG. 3A is configured to provide power to the first load 150 with four parallel sources of power, the first of which includes cells 330, 340, 350, 360, and 370, the second of which includes cells 332, 342, 352, 362, and 372, the third of which includes cells 334, 344, 354, 364, and 374, and the fourth of which includes cells 336, 346, 356, 366, and 376. Also, in this example diagram 300A, the reconfigurable battery pack 210a provides power to the second load 190 with two parallel sources of power, the first of which includes cells 310, 312, 314, and 316 in series, and the second of which includes cells 320, 322, 324, and 326 in series.

In this example reconfigurable battery pack 210a, the electrical connectivity between the cells can be changed by opening and/or closing switches between the cells so that at least one cell can switch from being part of the power source for the first load 150 to being part of the power source for the second load 190, or vice versa, by connect to and/or disconnected from a neighboring cell and/or a conducting line to one of the loads, for example.

The diagrams 300A of FIG. 3A and 300B of FIG. 3B illustrate how reconfiguration within the reconfigurable battery pack 210a can provide direct power to the two different loads, such as the first load 150 and the second load 190. For example, in certain instances, the second load 190 may require less power than as in the illustrated example in FIG. 3A. In such instances, the electrical connectivity of the cells 320, 322, 324, and 326 to neighboring cells and/or conducting lines to one of the loads can be changed so that the reconfigurable battery pack 210a can be reconfigured to provide power to the second load 190 with only the cells 310, 312, 314, and 316, while the cells 320, 322, 324, and 326 can be disconnected from the second load 190, and connect to the cells powering the first load 150 as shown in the diagram 300B in FIG. 3B. Similarly, the connectivity of the rows of columns of cells can be otherwise changed to vary the power and/or voltage provided to the first load 150 and the second load 190. In certain instances, all the cells in the reconfigurable battery pack 210a can be configured to connect and provide power to the first load 150, for example, when the low voltage battery 115 (FIG. 2B) is full charged and the second load 190 can be powered by the fully charged low voltage battery 115.

As the power and/or voltage level provided to the first load 150 and the second load 190 can be varied according to this embodiment, implementing the disclosed herein may entail selecting appropriate structure or dimensions of the reconfigurable battery pack 210, determining and designing the adjustable connections to the first load 150 and the second load 190 not to exceed maximum level of power or voltage of each load, and implementing cell connectivity control schemes with the switches between the cells controllable by one or more signals from, for example, the battery management system 260 (FIGS. 2A-2B). Also as discussed in connection with FIG. 4 below, the reconfigurable battery pack 210 can be implemented with partial reconfigurability depending on the desired level of switching or redirecting of power between multiple loads that are directly connected to the reconfigurable battery pack 210.

For example, the disclosed herein can be implemented in an electric vehicle, with the first or high voltage load 150 being the mechanical load while the second or low voltage load 190 being the electronics system. In such example implementations, the reconfigurable battery pack 210 can include, for example, 4 rows and 125 columns of cells, each cell having 3 V across. In certain configurations, all the cells in the reconfigurable battery pack 210 can be connected to the high voltage mechanical load of the vehicle to provide full power to it. In such configurations, the 125 cells in each row can be connected in series to provide the total voltage of 375 V to the first load 150, and the 4 rows can be connected in parallel similar to how the rows of cells in FIGS. 3A-3B are connected in parallel to provide power to the first load 150. In other configurations, the electrical connectivity of the one left most column of 4 cells, for example, can be reconfigured to provide power to a low voltage second load. In such configurations, the 4 cells in one column can be connected in series to provide 12 V to the low voltage load of the vehicle while the remaining 124 cells in each row can be connected in series to provide the total voltage of 372 V with the 4 rows still connected in parallel to the mechanical load. In the example implemented in an electric vehicle, the reconfigurable battery pack 210 can be partially reconfigurable as only a small portion of the total cells may be necessary to provide full power to the second low voltage load, which can reduce cost and complexity.

It can be advantageous to implement the reconfigurable battery pack disclosed herein as it allows the battery pack to provide direct adjustable power to different, isolated loads of widely varying voltage and power requirements. Also, the disclosed reconfigurable battery pack allows elimination of a DC/DC converter that would otherwise be coupled to the battery pack and can result in reduction in cost, component, and complexity. Although the certain embodiments discussed herein shows variable voltage and power provided to one load (e.g., 150) and fixed voltage and variable power provided to another load, in other embodiments, the arrangements of the cells and the switchable inter-cell connectivity design can be such that one or both of voltage and power for multiple loads can be variable. For instance, the cells need not be reconfigurable in a column-by-column manner as in some embodiments, the second load connectivity may not involve the entire column of cells. As such, in other embodiments, the reconfigurability can be more modular, and the voltage and power level provided to the directly connected loads can be more variable.

Further details regarding change or reconfiguration of cell connectivity are discussed in connection with FIG. 4 below.

FIG. 4 is a circuit diagram of an example reconfigurable battery pack according to one embodiment. The illustrated reconfigurable battery pack 210b includes a plurality of cells that are partially reconfigurable. It is to be noted that the reconfigurable battery pack 210b in FIG. 4 is only one example embodiment of the reconfigurable battery pack 210, and the reconfigurable battery pack 210 can include more or less cells in other embodiments. In this example diagram 400, the reconfigurable battery pack 210b is partially reconfigurable and provides power directly to the first load 150 and the second load 190. The reconfigurable portion of the reconfigurable battery pack 210b includes cells 402, 404, 406, 412, 414, and 416, and this reconfigurable portion can be configured or reconfigured to power either the first load 150 or the second load 190 based on the inter-cell connectivity established by the switches coupled to the cells. The reconfigurable battery pack 210b in this example also includes a designated portion 460 of the reconfigurable battery pack 210b that includes cells 422, 424, 426, 432, 434, 436, 442, 444, and 446. It is to be noted that the number and arrangement of the cells in FIG. 4 only illustrate one example implementation, and in other embodiments, the reconfigurable battery pack 210 can include more or less columns, such as column 450, more or less rows, such as row 470, and more or less designated or non-reconfigurable portion 460. In some embodiments, all the cells can be reconfigurable, and the reconfigurable battery pack 210 may not have any designated portion, such as the portion 460.

The cells in the reconfigurable portion of the reconfigurable battery pack 210b in this example can change their connectivity to their neighboring cells or conducting lines to one of the first load 150 and the second load 190. For example, through the coupled switches, the negative node of the cell 414 can connect to the positive node of the cell 412, the positive node of the cell 404, the negative node of the cell 413, and/or ground that is connected to the negative conducting line to the second load 190. The positive node of the cell 414 can connect to the negative node of the cell 416 or the negative node of the cell 416.

In the illustrated configuration, all the cells in the reconfigurable battery pack 210b are connected to power the first load 150. As such, the cells 402, 412, 422, 432, and 442 are connected in series; the cells 404, 414, 424, 434, and 444 are connected in series; and the cells 406, 416, 426, 436, and 446 are connected in series. And these series-connected cells are connected in parallel to provide power to the first load 150 similar to how certain cells discussed above are connected to provide power to the first load 150 as shown in FIGS. 3A-3B. In another configuration, the cells in the reconfigurable portion of the reconfigurable battery pack 210b can be connected to the second load 190. For example, in certain instances the connectivity of the cells 402, 404, and 406 can be changed so that the cell 402 is disconnected from the cell 412, the cell 404 disconnected from the cell 414, the cell 406 disconnected from the cell 416. Instead the cells 402, 404, and 406 can be connected in series to the second load. The cells 412, 414, and 416 that are respectively disconnected from the cells 402, 404, and 406 can be connected to ground at their negative nodes while their respective connectivity to the cells 422, 424, and 426 is unchanged. In this configuration, the cells 412, 422, 432, and 442 connected in series, the cells 414, 424, 434, and 444 connected in series, and the cells 416, 426, 436, and 446 connected in series can provide power to the first load 150 in parallel. Similarly, when more power is needed for the second load 190, for example, the connectivity of the cells 412, 414, and 416 can be changed so that more cells are redirected from powering the first load 150 to powering the second load 150. In some embodiments, certain combinations of switches illustrated in FIG. 4 can be implemented with N-way selectors allowing reconfiguration of the inter-cell connections. As illustrated in FIG. 4, certain cells, such as the cells 402, 404, and 406 can be accompanied with reduced number of switches as they can be directly coupled to one of the positive or negative conducting lines to the first or second loads 190, 150.

In electric vehicle applications, the disclosed herein can be implemented with 4 rows and 125 columns of reconfigurable units, such as cells, each providing 3 V. In such applications, the reconfigurable portion of the reconfigurable battery pack 210 may be one column of cells capable of providing 12 V to the low voltage second load 190 while the remaining 124 columns of cells can be dedicated to powering the high voltage first load 150 as discussed above in connection with FIGS. 3A-3B. The switches coupled to the cells in the reconfigurable battery pack 210b can be controlled by, for example, one or more controllers or processors in the battery management system 260. In electric vehicle applications, the battery management system 260 can be responsible for additional functions relevant to maintenance and operation of the battery-based powering system of an electric vehicle, such as monitoring temperature, voltage, and current data and executing other power management algorithms.

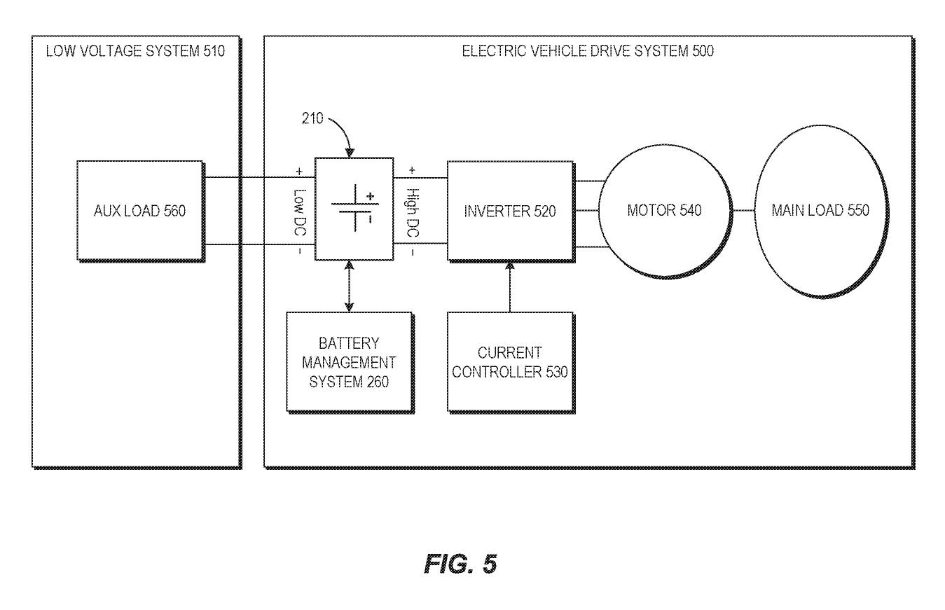

FIG. 5 is an example application of a reconfigurable battery pack in an electric vehicle. The illustrated example in FIG. 5 includes an electric vehicle drive system 500 and a low voltage system 510. The electric vehicle drive system 500 includes the reconfigurable battery 210, an inverter 520 coupled to the reconfigurable battery 210, a current controller 530, a motor 540, and main load 550, and the battery management system 260. The low voltage system 210 includes an auxiliary or secondary load 560, which is powered by low DC voltage from the reconfigurable battery 210.

Although the reconfigurable battery 210 is illustrated as a single element in FIG. 5, the reconfigurable battery 210 depicted in FIG. 5 is only representational, and further details of the reconfigurable battery 210 are discussed above in connection with FIGS. 3-4. As previously discussed the reconfigurable battery 210 can directly provide high DC voltage and low DC voltage. In some embodiments, the reconfigurable battery 210 can be configured to directly recharge a low DC rechargeable battery as discussed above in connection with FIG. 2B. In some embodiments, the reconfigurable battery 210 can be a rechargeable electric vehicle battery or traction battery used to power the propulsion of an electric vehicle including the drive system 500.

The inverter 520 includes power inputs which are connected to conductors of the reconfigurable battery 210 to receive, for example, DC power, single-phase electrical current, or multi-phase electrical current. Additionally, the inverter 520 includes an input which is coupled to an output of the current controller 530, described further below. The inverter 520 also includes three outputs representing three phases with currents that can be separated by 120 electrical degrees, with each phase provided on a conductor coupled to the motor 540. It should be noted that in other embodiments inverter 520 may produce greater or fewer than three phases.

The motor 540 is fed from voltage source inverter 520 controlled by the current controller 530. The inputs of the motor 540 are coupled to respective windings distributed about a stator. The motor 540 can be coupled to a mechanical output, for example a mechanical coupling between the motor 540 and main mechanical load 550. The main mechanical load 550 may represent one or more wheels of the electric vehicle.

The controller 530 can be used to generate gate signals for the inverter 520. Accordingly, control of vehicle speed is performed by regulating the voltage or the flow of current from the inverter 520 through the stator of the motor 540. There are many control schemes that can be used in the electric vehicle drive system 500 including current control, voltage control, and direct torque control. Selection of the characteristics of inverter 520 and selection of the control technique of the controller 530 can determine efficacy of the drive system 500.

The battery management system 260 can receive data from the battery 110 and generate control signals to manage the battery 210, such as reconfiguration control signals. In some embodiments, the battery management system 260 can also include one or more components for communicating and sending and receiving data within the battery management system 260 and/or with other components or circuitries in the electric vehicle. For example, the various components and circuits within the drive system 500, including components in the battery management system 260 can be in communication with one another using protocols or interfaces such as a controller area network (CAN) bus, serial peripheral interface (SPI), or other suitable protocols or interfaces. And in some embodiments, the processing of incoming data can be at least in part performed by other components not in the battery management system 260 within the electric vehicle as the battery management system 260 communicates with other components.

The low voltage auxiliary load 560 in an electric vehicle application can be certain electronic loads that often require much less power than the main mechanical load 550. Example auxiliary load 560 in an electric vehicle can include the entertainment system, lighting system, door and window lock system, and other similar digital or analog circuits or electronics-based systems. An example voltage level provided to the auxiliary load 560 in an electric vehicle can be 12 V, which can further be converted to various different voltage levels, such as 3 V, 5 V, etc., as needed by various sub-parts or systems within the auxiliary load 560.

Although not illustrated, the electric vehicle drive system 500 can include one or more position sensors for determining position of the rotor of the motor 540 and providing this information to the controller 530. For example, the motor 540 can include a signal output that can transmit a position of a rotor assembly of the motor 540 with respect to the stator assembly of the motor 540. The position sensor can be, for example, a Hall-effect sensor, a magnetoresistive sensor, potentiometer, linear variable differential transformer, optical encoder, or position resolver. In other embodiments, the saliency exhibited by the motor 540 can also allow for sensorless control applications. Although not illustrated, the electric vehicle drive system 500 can include one or more current sensors for determining phase currents of the stator windings and providing this information to the controller 530. The current sensor can be, for example, a Hall-effect current sensor, a sense resistor connected to an amplifier, or a current clamp.

It should be appreciated that while the motor 540 is described as an electrical machine that can receive electrical power to produce mechanical power, it can also be used such that it receives mechanical power and thereby converts that to electrical power. In such a configuration, the inverter 520 can be utilized to excite the winding using a proper control and thereafter extract electrical power from the motor 540 while the motor 540 is receiving mechanical power.

The foregoing description and claims may refer to elements or features as being “connected” or “coupled” together. As used herein, unless expressly stated otherwise, “connected” means that one element/feature is directly or indirectly connected to another element/feature, and not necessarily mechanically. Likewise, unless expressly stated otherwise, “coupled” means that one element/feature is directly or indirectly coupled to another element/feature, and not necessarily mechanically. Thus, although the various schematics shown in the Figures depict example arrangements of elements and components, additional intervening elements, devices, features, or components may be present in an actual embodiment (assuming that the functionality of the depicted circuits is not adversely affected).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like. Further, a “channel width” as used herein may encompass or may also be referred to as a bandwidth in certain aspects.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules, and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

It is to be understood that the implementations are not limited to the precise configuration and components illustrated above. Various modifications, changes and variations may be made in the arrangement, operation and details of the methods and apparatus described above without departing from the scope of the implementations.

Although this invention has been described in terms of certain embodiments, other embodiments that are apparent to those of ordinary skill in the art, including embodiments that do not provide all of the features and advantages set forth herein, are also within the scope of this invention. Moreover, the various embodiments described above can be combined to provide further embodiments. In addition, certain features shown in the context of one embodiment can be incorporated into other embodiments as well.

What is claimed is:

1. An apparatus comprising:
a battery pack comprising:
a plurality of battery units; and
a plurality of reconfiguration switches coupled to the plurality of battery units; and
a controller coupled to the battery pack, the controller being configured to activate one or more reconfiguration switches,
wherein at least one of the plurality of battery units is connectable in a first state or a second state when the one or more reconfiguration switches are activated, the first state being coupled to a first load providing a first voltage, and the second state being coupled to a second load providing a second voltage.

2. The apparatus of claim 1, wherein the first voltage and the second voltage are different.

3. The apparatus of claim 2, wherein the first voltage and the second voltage are different by at least one order of magnitude in volts (V).

4. The apparatus of claim 1, wherein the first load and the second load are isolated, and wherein the first load and the second load are not coupled to a rechargeable voltage source other than the battery pack.

5. The apparatus of claim 1, wherein the controller is coupled to a processor, and wherein the controller is configured to activate some of the reconfiguration switches based in part on a control signal from the processor.

6. The apparatus of claim 1, wherein at least some of the plurality of battery units are in the first state, and wherein another at least some of the plurality of battery units are in the second state.

7. The apparatus of claim 1, wherein for at least some of the plurality of battery units, being in the first state comprises being connected to a first subset of neighboring one or more battery units and being in the second state comprises being connected to a second subset of neighboring one or more battery units, wherein the first subset and the second subset are different.

8. A reconfigurable battery pack comprising:
a dedicated voltage source portion configured to provide power to a high voltage load; and
a reconfigurable voltage source portion configured to provide power to either a high voltage load or a low voltage load.

9. The reconfigurable battery pack of claim 8, wherein the reconfigurable voltage source portion comprises a plurality of battery units coupled to a plurality of reconfiguration switches.

10. An electric vehicle comprising the reconfigurable battery pack of claim 8, wherein the electric vehicle is without a voltage converter coupled to the reconfigurable battery pack.

11. The electric vehicle of claim 10, wherein the electric vehicle is without a rechargeable voltage source other than the reconfigurable battery pack.

12. The electric vehicle of claim 10, wherein the reconfigurable voltage source portion is further configured to directly charge a rechargeable low voltage battery.

13. The electric vehicle of claim 10, wherein the high voltage load comprises a vehicle drive system.

14. The electric vehicle of claim 10, wherein the reconfigurable battery pack provides a voltage greater than 300 V to the high voltage load and a voltage less than 30 V to the low voltage load.

15. The electric vehicle of claim 10, wherein the reconfigurable voltage source portion switches between being coupled to the high voltage load and being coupled to the low voltage load based in part on a control signal from a processor.

16. An electric vehicle comprising:
a motor coupled to one or more wheels of the electric vehicle;
an inverter coupled to the motor;
at least a first power bus coupled to the inverter;
a low voltage load isolated from the first power bus; and
a reconfigurable battery pack directly coupled to the first power bus and the low voltage load.

17. The electric vehicle of claim 16, wherein the electric vehicle is without a voltage converter coupled to the reconfigurable battery pack.

18. The electric vehicle of claim 16, wherein the reconfigurable battery pack comprises a dedicated voltage source portion providing power to the first power bus and a reconfigurable voltage source portion providing power to either the first power bus or the low voltage load.

19. The electric vehicle of claim 16, wherein the reconfigurable battery pack comprises a plurality of battery units coupled to a plurality of reconfiguration switches, and wherein the reconfiguration switches are configured to change electric connectivity between one another of at least some of the plurality of battery units.

20. The electric vehicle of claim 19, wherein the reconfiguration switches change electric connectivity between one another of the at least some of the plurality of battery units based in part on a control signal from a processor.
